(19) United States
(12) Patent Application Publication
(10) Pub. No.: US 2019/0130046 A1
(43) Pub. Date: May 2, 2019

(54) GENERATING DEVICE, TERMINAL DEVICE, SHARED PAGE GENERATING SYSTEM, GENERATING METHOD, AND STORAGE MEDIUM

(71) Applicant: SHARP KABUSHIKI KAISHA, Sakai City (JP)

(72) Inventors: HIROYUKI OONISHI, Sakai City (JP); MOTOKI SONE, Sakai City (JP); TSUYOSHI YAMAGUCHI, Sakai City (JP); HIROAKI KONDO, Sakai City (JP)

(21) Appl. No.: 16/168,725

(22) Filed: Oct. 23, 2018

(30) Foreign Application Priority Data
Oct. 26, 2017 (JP) 2017-207313

(51) Int. Cl. G06F 17/30

(52) U.S. Cl. CPC G06F 17/30893; G06Q 50/01; G06F 17/30887; G06F 17/30902

(57) ABSTRACT

The generating device (3, 3a, 3b) includes a control section (20, 20a, 20b) and a communication section (29). The control section obtains data via the communication section (29), which data indicates a content which has been caused to be displayed on a display screen of a terminal device (2, 2a) by an application, and the control section generates a shared page including the content.

This Nonprovisional application claims priority under 35 U.S.C. § 119 on Patent Application No. 2017-207313 filed in Japan on Oct. 26, 2017, the entire contents of which is hereby incorporated by reference.

### TECHNICAL FIELD

The present invention relates to a generating device, a terminal device, a shared page generating system, a generating method, and a storage medium.

### BACKGROUND ART

As a conventional technique, Patent Literature 1 discloses a technique in which a server generates recommendation information on a content that suits a taste and the like of a particular user, and the server transmits the recommendation information to a terminal of the user.

### CITATION LIST

### Patent Literature

Patent Literature 1: Japanese Patent Application Publication, Tokukai, No. 2011-71880 (Publication Date: Apr. 7, 2011)

### SUMMARY OF INVENTION

### Technical Problem

A technique called “social button (SNS button)” is known in which a user shares information on a web page with another user with use of a social networking service (SNS). This is a technique to configure an application such that, for example, in a case where a user has pressed a predetermined button on a screen while the user is browsing a web page with use of the application such as a web browser, a screen for posting a message on an SNS is displayed in a state in which the message includes pieces of information such as link information (uniform resource identifier (URI) or uniform resource locator (URL)) to the web page, title information of the web page, and an eye-catching image indicating a main content of the web page. With the technique, the user can easily share, via the message, information on the web page with another user who browses the message.

However, according to the conventional technique, it is difficult to share recommendation information transmitted by a server with another user by using a simple method such as the social button technique. This is because of the following reasons: that is, such information varies depending on users, terminals, and times; the information is therefore dynamically generated by the server according to need and; after the information is transmitted to a terminal, the information is merely discarded without being stored in the server, such that a storage of the server will not become scarce. A link to such information that is dynamically generated by a server or the like cannot be created, and therefore the social button technique cannot be applied.

An aspect of the present invention is accomplished in view of the problem, and its object is to provide a generating device that enables sharing of dynamically-generated information with another user by a simple method.

### Solution to Problem

In order to attain the object, a generating device in accordance with an aspect of the present invention includes: a control section; and a communication section, the control section obtaining data via the communication section, the data indicating a content which has been caused to be displayed on a display screen of a terminal device by an application running on the terminal device, and the control section generating, with reference to the data, a shared page including the content.

### Advantageous Effects of Invention

According to an aspect of the present invention, it is possible to provide the generating device that enables sharing of dynamically-generated information with another user by a simple method.

### BRIEF DESCRIPTION OF DRAWINGS

FIG. 1 is a functional block diagram illustrating a shared page generating system 1 in accordance with Embodiment 1.

FIG. 2 is a sequence diagram showing a flow of processes in a terminal device 2 and a generating device 3 in accordance with Embodiment 1.

FIG. 3 is a view illustrating an example of a display screen on a predetermined application.

FIG. 4 is a view illustrating an example of an SNS message posting screen.

FIG. 5 is a view illustrating an example of a display aspect of the terminal device 2 to display a content on a display screen (display section 17), the display aspect corresponding to a category of the content.

FIG. 6 is a view illustrating an example of a display aspect of the terminal device 2 to display a content on a display screen (display section 17), the display aspect corresponding to a category of the content.

FIG. 7 is a sequence diagram showing a flow of processes in a terminal device 2 and a generating device 3 in accordance with Embodiment 2.

FIG. 8 is a sequence diagram showing a flow of processes in a terminal device 2 and a generating device 3 in accordance with a modification example of Embodiment 2.

FIG. 9 is a functional block diagram illustrating a shared page generating system 1a in accordance with Embodiment 3.

FIG. 10 is a sequence diagram showing a flow of processes in a terminal device 2a and a generating device 3a in accordance with Embodiment 3.

FIG. 11 is a functional block diagram illustrating a shared page generating system 1b in accordance with Embodiment 4.

FIG. 12 is a block diagram illustrating an example configuration of a computer 910 that can be used as the terminal device 2 or the generating device 3.

### DESCRIPTION OF EMBODIMENTS

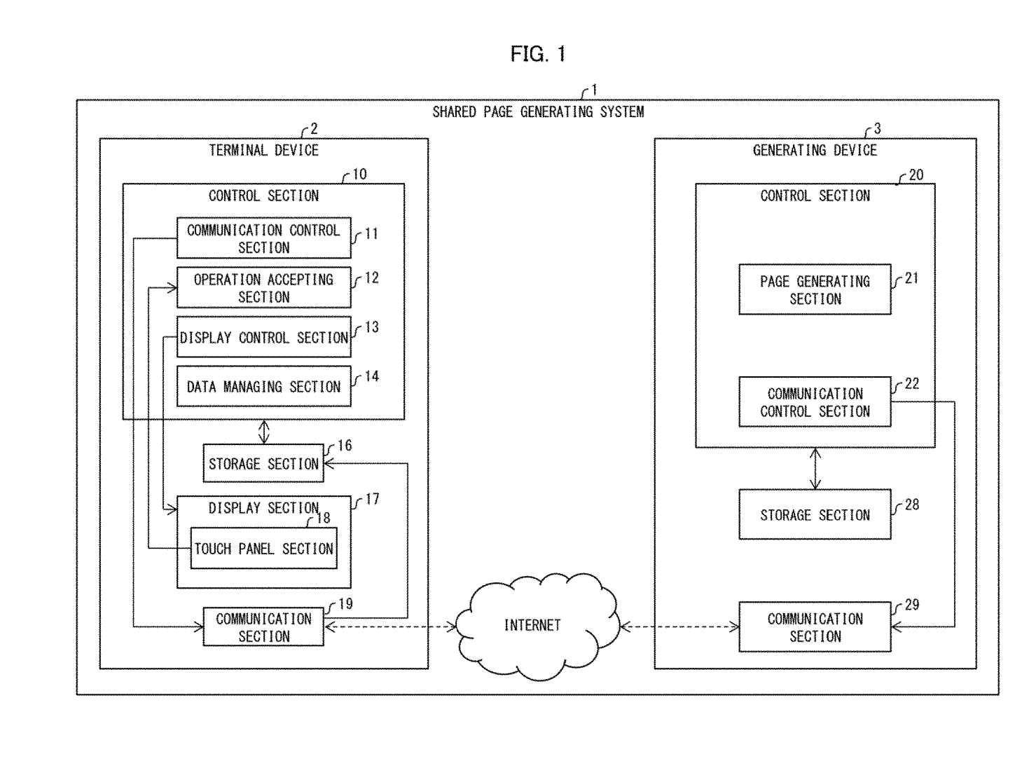

The following description will discuss embodiments of the present invention with reference to FIGS. 1 through 12.

### Embodiment 1

The following description will discuss an embodiment of the present invention with reference to FIGS. 1 through 6.

In Embodiment 1, a configuration will be described in which a generating device generates a shared page (i.e., a web page for which link information (URI) has been set and which is opened to all of or a part of users so that information is shared with other user(s); the same applies hereinafter) that corresponds to contents dynamically displayed on a screen of the terminal device, and the shared page is viewed on the terminal device.

Note that the term “dynamic” means that a content to be displayed on the screen is generated every time the content is referred to (this also includes the following case: that is, a generated content is temporarily maintained with use of a so-called cache technique and then the content thus maintained is reused when, within a predetermined short period (e.g., within one hour) from the start of maintaining the content, reference (e.g., reference from the same source or reference with the same parameter) is made for which a content identical with the maintained content needs to be generated). That is, details or a form of a dynamic content or the like can vary every time the content is generated or displayed. On the other hand, a term “static” means that details and an aspect of a generated content or the like are fixed and do not vary every time the generated content is referred to (the “static” case also includes updating of the content at a point of time that is irrelevant to reference).

Note that the “content” includes recommendation information for recommending a predetermined content. Moreover, a term “object” is a generic term representing various components (such as buttons and widgets) constituting a displayed screen.

[1. Configuration of Shared Page Generating System 1]

The following description will discuss a configuration of Embodiment 1 with reference to FIG. 1.

FIG. 1 is a functional block diagram illustrating a shared page generating system 1 in accordance with Embodiment 1.

As illustrated in FIG. 1, the shared page generating system 1 includes a terminal device 2 and a generating device 3.

The terminal device 2 includes a display section 17, a communication section 19, a storage section 16, and a control section 10.

The display section 17 is a display panel for displaying a moving image, and includes a touch panel section 18. The touch panel section 18 is provided on the display section 17 or is integrated with the display section 17, and carries out control for detecting contact of an object with respect to the display section 17.

The communication section 19 communicates with the generating device 3 and the like. The storage section 16 stores various kinds of data.

The control section 10 is a control circuit for comprehensively controlling the entire terminal device 2, and serves also as a communication control section 11, an operation accepting section 12, a display control section 13, and a data managing section 14. The communication control section 11 controls data communication that is carried out by the communication section 19. The operation accepting section 12 receives a signal indicative of how an object has made contact with the touch panel section 18, and carries out control in accordance with the signal. Hereinafter, in this specification, the above operations of the touch panel section 18 and the operation accepting section 12 will not be repeatedly described, in a case where a user touches a predetermined button or the like on the display section 17.

The display control section 13 controls the display section 17 to display various contents (such as a web page) and objects. The data managing section 14 generates or extracts data for generating a shared page.

The generating device 3 includes a storage section 28, a communication section 29, and a control section 20.

The storage section 28 stores various kinds of data. The communication section 29 communicates with the terminal device 2 and the like. The control section 20 is a control circuit for comprehensively controlling the entire generating device 3, and serves also as a page generating section 21 and a communication control section 22.

The page generating section 21 generates a web page including a shared page.

The communication control section 22 controls data communication that is carried out by the communication section 29.

Note that the number of each of the constituent members included in the terminal device 2 and the generating device 3 is not limited to one, and it is possible to employ a configuration in which the number of each of the constituent members is two or more.

[2. Flow of Processes]

The following description will discuss, with reference to FIGS. 1 through 6, a flow of processes step by step until a content included in a dynamic content is posted in an SNS with use of the terminal device 2.

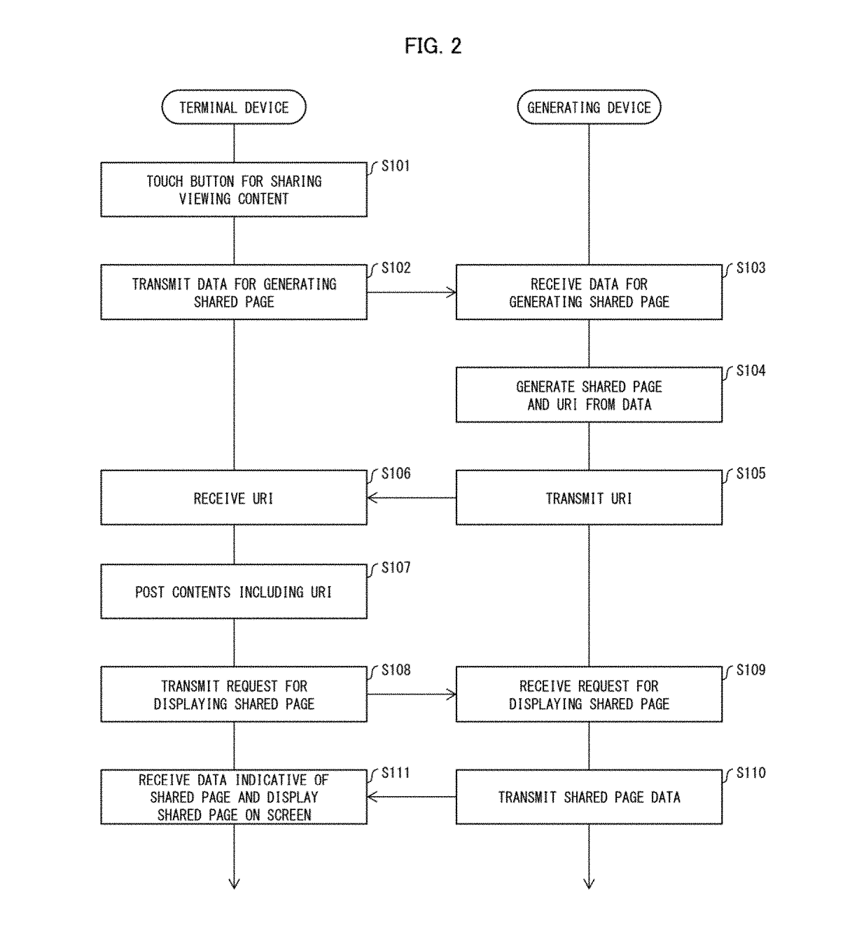

FIG. 2 is a sequence diagram showing a flow of processes in the terminal device 2 and the generating device 3 in accordance with Embodiment 1.

(S101)

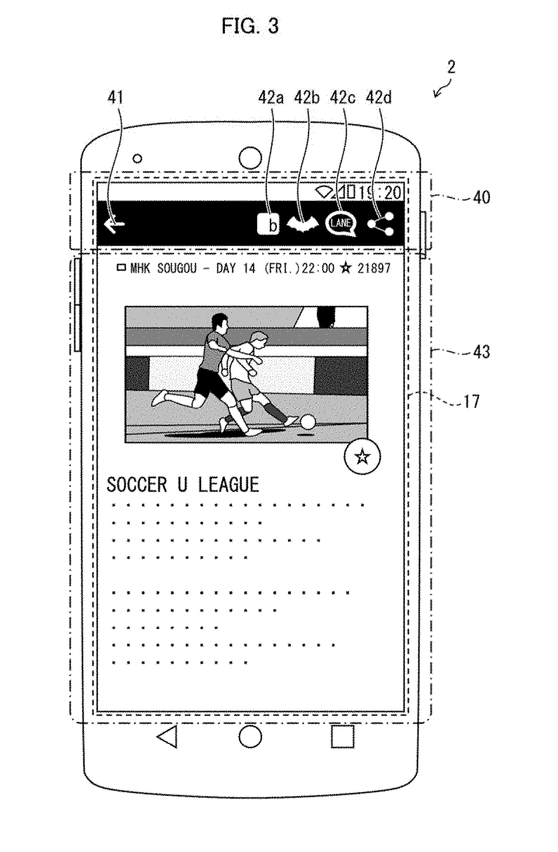

FIG. 3 is a view illustrating an example of a display screen on a predetermined application.

The display screen illustrated in FIG. 3 includes a menu bar 40 and a content display region 43.

Note that, among the display screen displayed on the display section 17, at least a screen that is displayed in the content display region 43 is dynamically generated.

The menu bar 40 includes a return button 41 and SNS buttons 42a through 42d. In a case where the user has touched the return button 41, the display control section 13 controls the display section 17 to display a screen which was displayed immediately before.

Each of the SNS buttons 42a through 42d is used to post a sentence and the like in a corresponding SNS.

The content display region 43 is displaying information on a predetermined video-on-demand content.

In a case where the user has touched any of the SNS buttons 42a through 42d, the process proceeds to a step S102.

(S102)

The data managing section 14 generates or extracts data that is used to generate a shared page based on a displayed content in the content display region 43. Note that the displayed content includes a content to be displayed in the content display region 43 when the user scrolls the touch panel section 18.

The data for generating a shared page includes the followings:
Data from which a shared page or metadata (header information) of a shared page is generated;
Data constituting a shared page or metadata of a shared page;
Data that serves as a trigger or a factor of generating a shared page or metadata of a shared page.

Therefore, the data for generating a shared page includes (i) a mere request to the generating device 3 for generating a shared page or (ii) a content ID, as later described in Embodiment 2.

The communication control section 11 transmits data to the generating device 3 via the communication section 19, the data being based on a displayed content in the content display region 43 and being used to generate a shared page.

As such, the terminal device 2 in accordance with Embodiment 1 includes: the control section 10; the communication section 19; and the display section 17, the control section 10 (communication control section 11) running an application so as to cause the display section 17 to display a content, and the control section 10 transmitting, via the communication section 19, data for generating a shared page including the content.

Note that, in this specification, a screen, a content, or an object which is displayed or has been displayed by an application means a screen, a content, or an object which the control section 10 (display control section 13) causes or has caused the display section 17 to display in accordance with operation of the application.

(S103)

The control section 20 receives, via the communication section 29, data which has been transmitted by the communication control section 11 in the step S102, and causes the storage section 28 to store the data.

(S104)

The page generating section 21 generates (i) a shared page with reference to the data stored in the storage section 28 in the step S103 and (ii) link information (URI) for linking to the shared page. Further, the page generating section 21 causes the storage section 28 to store the shared page and the link information such that the shared page can be viewed when the link information has been referred to.

That is, the generating device 3 in accordance with Embodiment 1 includes: the control section 20; the storage section 28; and the communication section 29, the control section 20 (communication control section 22) obtaining data via the communication section 29, the data indicating a content which has been caused to be displayed on a display screen of the terminal device 2 by an application running on the terminal device 2, and the control section 20 (page generating section 21) generating, with reference to the data, a shared page including the content. The control section 20 (page generating section 21) causes the storage section 28 to store the shared page which has been generated such that the shared page is viewed when the predetermined terminal device 2 or the like has referred to link information on the shared page.

The shared page including the content means a shared page which includes a part of or a whole of the content or a part of or a whole of details of the content.

Note that the content that can be caused, by the application running on the terminal device 2, to be displayed on the display screen of the terminal device 2 of course encompasses a web page.

(S105)

The communication control section 22 transmits the URI, which has been generated by the page generating section 21 in the step S104, to the terminal device 2 via the communication section 29.

(S106)

The communication control section 11 receives, via the communication section 19, the URI which has been transmitted by the communication control section 22 in the step S105, and causes the storage section 16 to store the URI.

(S107)

The display control section 13 causes the display section 17 to display an SNS message posting screen corresponding to the SNS button 42a, 42b, 42c, or 42d which has been touched by the user.

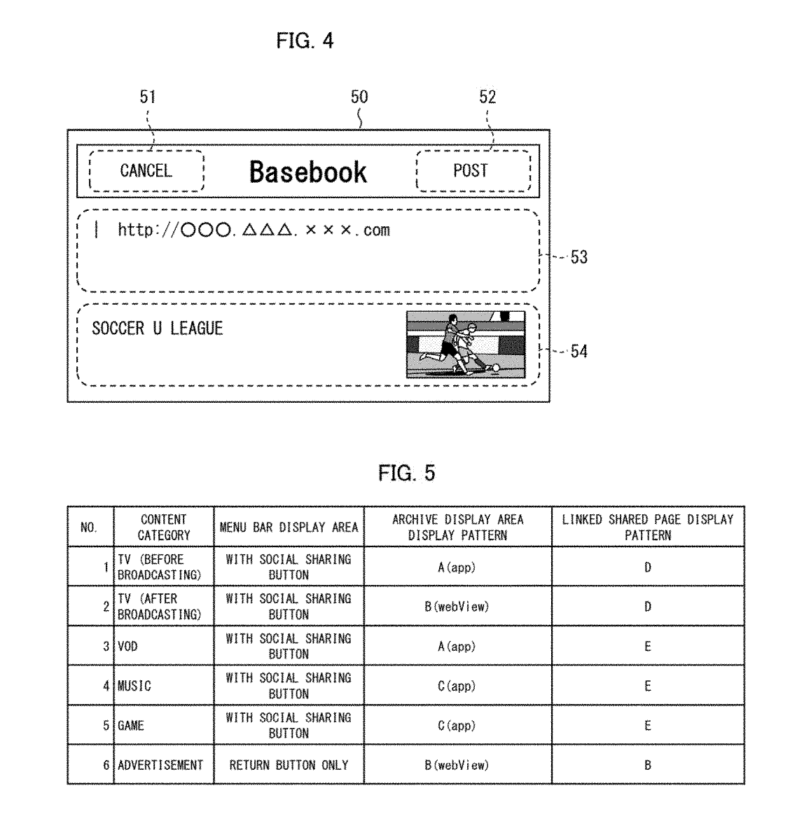

FIG. 4 is a view illustrating an example of the SNS message posting screen.

An SNS message posting screen 50 includes a cancel button 51, a posting button 52, a text area 53, and share link information 54. In a case where the user has touched the cancel button 51, a current screen returns to a previous screen which was displayed before the user touches any of the SNS buttons 42a through 42d. In a case where the user has touched the posting button 52, contents presented in the text area 53 and the share link information 54 are posted in a corresponding SNS. The text area 53 is a region in which the user writes contents to be posted. In this case, the URI stored in the storage section in the step S106 has already been written in the text area 53. The share link information 54 is information on a content which was displayed in the content display region 43 of the display section 17 in the step S101. The share link information 54 can include a title, an eye-catching image, or the like of the content. The URI, i.e., link information can be encompassed in the share link information 54.

The user touches the posting button 52 so as to post the contents including the URI on the SNS.

(S108)

The user touches the URI or URI information including the share link information in the contents posted on the SNS in the step S107.

The communication control section 11 transmits a display request (HTTP request) for a shared page to the generating device 3 via the communication section 19.

Note that processes in and after the step S108 can be carried out by operation, by another user who has seen the contents posted on the SNS, with respect to another terminal device that is connectable to the Internet. In other words, the processes in and after the step S108 can be carried out with use of a terminal device that is accessible to the SNS and is different from the terminal device 2 (or a terminal device 2a described later) which has executed the processes in and before the step S107. Moreover, the terminal device different from the terminal device 2 is not limited to a mobile terminal device such as a smart phone but can be a PC, a TV, or the like which is accessible to the SNS.

(S109)

The communication control section 22 receives the display request for the shared page via the communication section 29.

(S110)

The communication control section 22 transmits shared page data which is stored in the storage section 28 to the terminal device 2 via the communication section 29.

(S111)

The communication control section 11 receives, via the communication section 19, the shared page data which has been transmitted by the communication control section 22 in the step S110, and the display control section 13 causes the display section 17 to display a content based on the data. Note that a display aspect varies depending on the content. In other words, the control section 10 (display control section 13) causes the shared page to be displayed in an aspect that corresponds to a type of the shared page.

The following description will discuss examples of the display aspect corresponding to a type of the shared page.

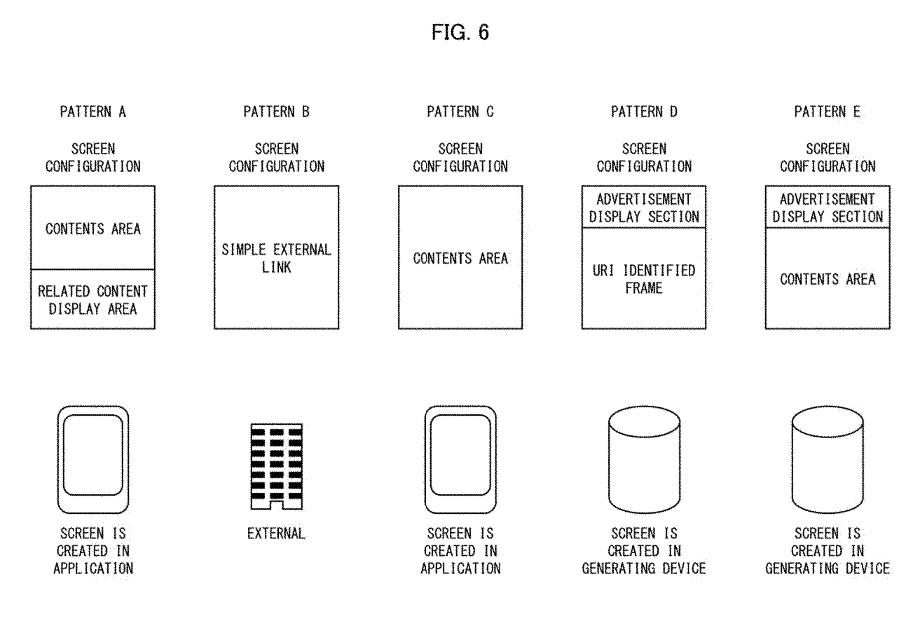

Each of FIGS. 5 and 6 is a view illustrating an example of a display aspect of a content that is caused to be displayed in the content display region 43 by the application, the display aspect corresponding to a category of the content.

As seen in a menu bar display area field shown in FIG. 5, the social button (SNS button) may be displayed or may not be displayed on the screen, depending on a category of a content to be displayed. An archive display area display pattern field is a screen display aspect before a shared page is generated, and can be roughly classified into (i) a screen that is generated by an application running on the terminal device 2 and (ii) a screen that displays a web page. A linked shared page display pattern means a screen display aspect in a case where the shared page is displayed on the terminal device 2.

Each of contents areas in some of patterns illustrated in FIG. 6 is a region for displaying a dynamically generated content and the like. A related content display area is a region for displaying a content relating to the content that is displayed in the contents area. A simple external link is a region for displaying a web page that is indicated by a predetermined URI. An advertisement display section is a region for displaying a predetermined advertisement. A URI identified frame is a region in which a part of or a whole of a web page indicated by the URI is embedded and displayed. In the archive display area display pattern field shown in FIG. 5, A(app), B(webView), and C(app) correspond to patterns A, B, and C in FIG. 6, respectively, and indicate examples of screen display aspects before a shared page is generated. Moreover, B, D, and E in the linked shared page display pattern shown in FIG. 5 correspond to patterns B, D, and E in FIG. 6, respectively, and indicate examples of screen display aspects in cases where the terminal device 2 displays a shared page that has been generated by a server in response to touch on the SNS button by the user.

Here, for example, in a case where a content whose category is video on demand (VOD) is displayed (see FIG. 5), the application displays a screen in the display aspect of the pattern A illustrated in FIG. 6 and then, when the user has touched the SNS button, the server generates a shared page that is to be displayed in the display aspect of the pattern E illustrated in FIG. 6.

According to the configuration, it is possible to provide the generating device 3 and the terminal device 2 with which even screen display contents that have been dynamically generated can be shared with another user via a shared page.

### Embodiment 2

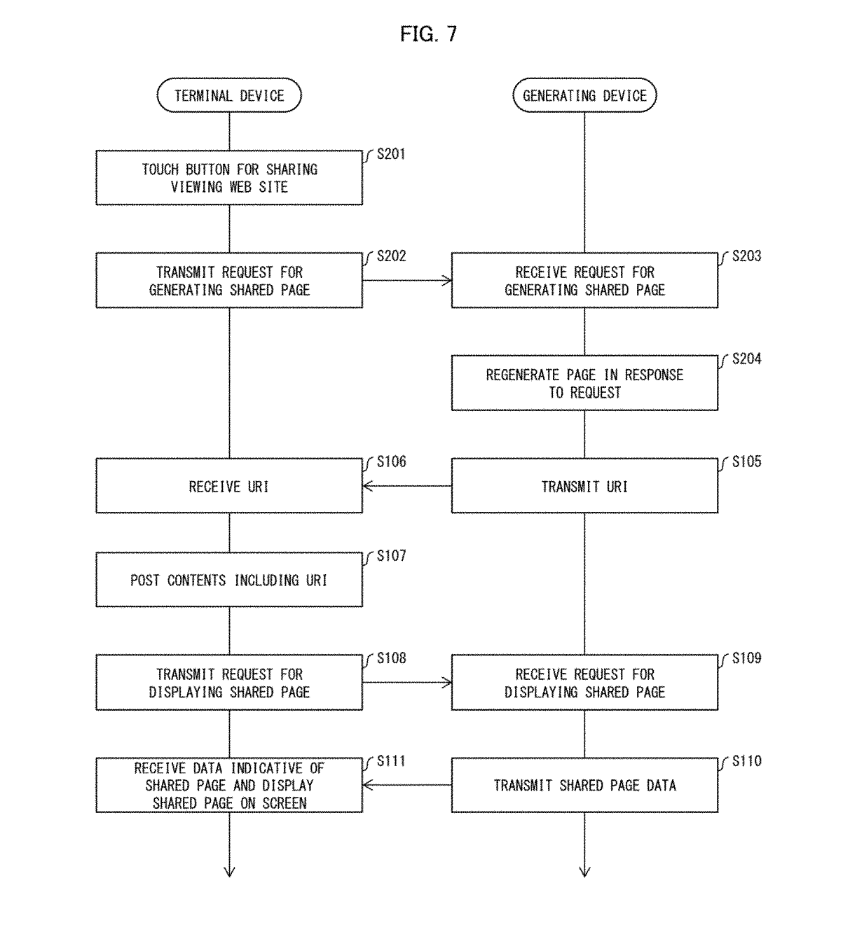

The following description will discuss another embodiment of the present invention with reference to FIG. 1, FIG. 3, and FIG. 7.

In Embodiment 2, a configuration will be described in which the user shares, with another user, a web page (website) that has been dynamically generated by the generating device 3.

[1. Configuration of Shared Page Generating System 1]

In Embodiment 2 also, the configuration illustrated in FIG. 1 is employed.

[2. Flow of Processes]

The following description will discuss, with reference to FIG. 7, a flow of processes until the terminal device 2 displays, on the screen, a shared page which has been generated based on a dynamic web page.

FIG. 7 is a sequence diagram showing a flow of processes in the terminal device 2 and the generating device 3 in accordance with Embodiment 2.

(S201)

It is assumed that the display section 17 is displaying, with an application such as a browser running on the terminal device 2, a dynamic content (see FIG. 3) that has been generated by the page generating section 21. The content is a dynamic web page which has been generated by the page generating section 21 from a program stored in the storage section 28 with reference to a request (e.g., HTTP request) transmitted from the terminal device 2.

Note that the dynamic web page means that contents in a web page can vary every time a web page is generated from the program.

The items included in the menu bar 40 can be provided as a part of a web page generated by the page generating section 21 or as a function included in an application such as a browser.

The web page is a dynamic web page that is generated by the page generating section 21 every time an HTTP request is transmitted from the terminal device 2, and therefore contents of the web page can vary, accordingly.

In a case where the user has touched any of the SNS buttons 42a through 42d, the process proceeds to a step S202.

(S202)

The communication control section 11 transmits a request for regenerating a web page to the generating device 3 via the communication section 19. Specifically, the request (i) is a request for regenerating a web page which was displayed on the display section 17 in the step S101 and (ii) is transmitted as data for generating a shared page that is based on displayed contents in the content display region 43. In other words, the data is (i) data indicative of the request which has been transmitted by the terminal device 2 in the step S201 or (ii) data including contents identical with those of the request.

(S203)

The communication control section 22 receives, via the communication section 29, the request which has been transmitted from the communication control section 11 in the step S202.

(S204)

In response to the request which has been received by the communication control section 22 in the step S203, the page generating section 21 regenerates, from a dynamic program that is stored in the storage section 28, a web page which is indicated by the request.

That is, the control section 20 (page generating section 21) generates a shared page which includes the contents of the dynamic web page with reference to (i) data indicative of the request which has been transmitted by the terminal device 2 in the step S201 or (ii) data including contents identical with those of the request.

That is, the control section 20 generates the shared page based on the data (i.e., the request for regeneration of the dynamic web page) that relates to the content which was displayed on the display screen of the terminal device 2.

Next, the control section 20 (page generating section 21) causes the storage section 28 to store the shared page which has been generated such that the web page can be viewed when the link information (URI) with respect to the shared page has been referred to.

(S105 through S111)

Processes in the step S105 through the step S111 are similar to those in Embodiment 1.

The above is the flow of processes based on the flowchart shown in FIG. 7.

According to the configuration, it is possible to provide the generating device 3 and the terminal device 2 with which a web page that has been dynamically generated can be shared with another user.

### Modification Example

In this modification example, a configuration will be described in which content IDs are assigned to respective contents to be displayed on the terminal device 2 or the like, and the generating device 3 generates a shared page when the terminal device 2 has transmitted any of the content IDs to the generating device 3.

[1. Configuration of Shared Page Generating System 1]

In this modification example also, the configuration illustrated in FIG. 1 is employed.

[2. Flow of Processes]

The following description will discuss, with reference to FIGS. 1, 3, and 8, a flow of processes step by step until the terminal device 2 displays a shared page.

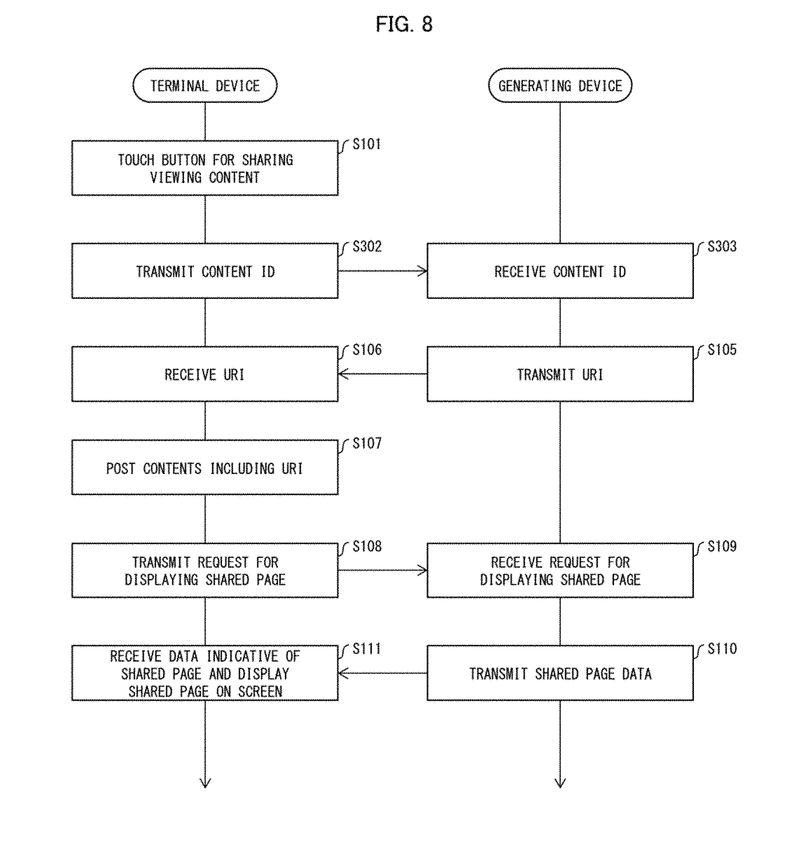

FIG. 8 is a sequence diagram showing a flow of processes in the terminal device 2 and the generating device 3 in accordance with the present modification example.

(S101)

It is assumed that the display section 17 is displaying the screen illustrated in FIG. 3, as with in the step S101 of Embodiment 1.

In a case where the user has touched any of the SNS buttons 42a through 42d, the process proceeds to a step S302.

(S302)

The communication control section 11 transmits, via the communication section 19, a content ID which corresponds to the content that is displayed on the display section 17 as illustrated in FIG. 3. Note that the content ID is included in the content as meta information.

(S303)

The communication control section 22 receives, via the communication section 29, the content ID which has been transmitted from the communication control section 11 in the step S302.

The storage section 28 stores, in advance, static shared pages which correspond to the respective content IDs.

That is, in the step S105 described later, the communication control section 22 transmits, to the terminal device, a URI of a static page corresponding to the content ID.

(S105 through S111)

Processes from the step S105 to the step S111 (i.e., from a process in which the generating device 3 transmits link information (URI) of the shared page stored in the storage section 28 to the terminal device 2 to a process in which the terminal device 2 causes the display section 17 to display the shared page) are similar to those in Embodiment 1.

The above is the flow of processes based on the flowchart shown in FIG. 8.

According to the configuration, only the content ID is transmitted from the terminal device 2 to the generating device 3, and it is therefore possible to reduce an amount of communication data. Moreover, the static page corresponding to the content ID has been prepared in advance, and it is therefore unnecessary for the generating device 3 to generate a shared page every time the content is referred to. This brings about an effect of saving a processing resource.

### Embodiment 3

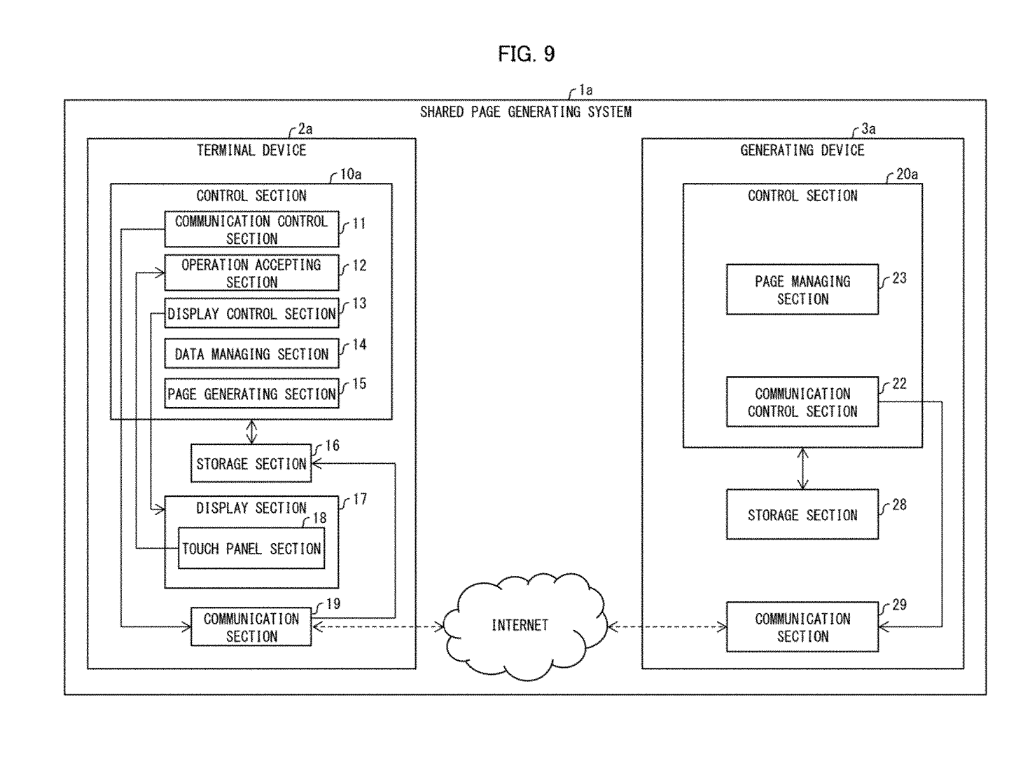

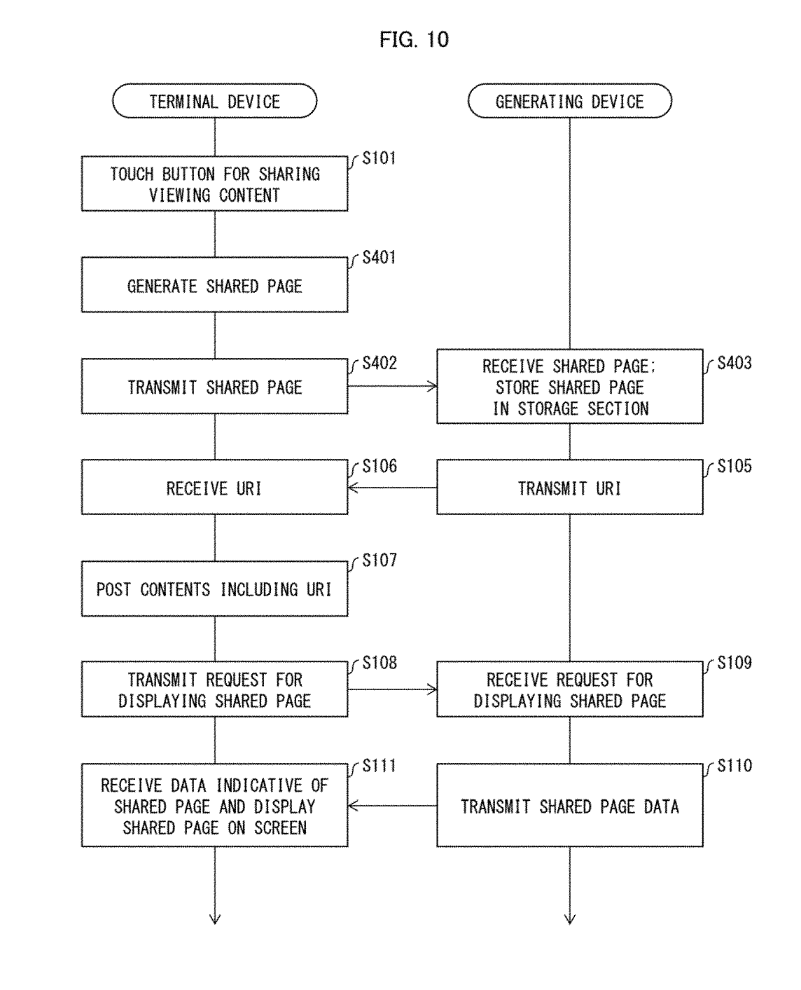

The following description will discuss another embodiment of the present invention with reference to FIG. 3, FIG. 9, and FIG. 10. In Embodiment 3, a configuration will be described in which a terminal device generates a shared page.

[1. Configuration of Shared Page Generating System 1a]

The following description will discuss a configuration of a shared page generating system 1a in accordance with Embodiment 3, with reference to FIG. 9.

FIG. 9 is a functional block diagram illustrating a shared page generating system 1a in accordance with Embodiment 3.

As illustrated in FIG. 9, in the shared page generating system 1a, a control section 10a includes a page generating section 15, as compared with the shared page generating system 1.

[2. Flow of Processes]

The following description will discuss, with reference to FIG. 10, a flow of processes in which the terminal device 2a generates a shared page. FIG. 10 is a sequence diagram showing a flow of processes in a terminal device 2a and a generating device 3a in accordance with Embodiment 3.

(S101)

It is assumed that the display section 17 is displaying the screen illustrated in FIG. 3, as with in the step S101 of Embodiment 1.

In a case where the user has touched any of the SNS buttons 42a through 42d, the process proceeds to a step S401.

(S401)

The page generating section 15 generates a shared page based on the display screen illustrated in FIG. 3.

(S402)

The communication control section 11 transmits data of the shared page which has been generated by the page generating section 15 in the step S401 to the generating device 3 via the communication section 19.

That is, the terminal device in accordance with Embodiment 3 includes: the control section 10a; the communication section 19; and the display section 17, the control section 10a (page generating section 15 and communication control section 11) running an application so as to cause the display section 17 to display a content, and the control section 10a generating a shared page including the content and transmitting the shared page via the communication section 19.

(S403)

The communication control section 22 receives, via the communication section 29, the shared page which has been transmitted from the communication control section 11 in the step S402. The control section 20 (page managing section 23) causes the storage section 28 to store the shared page such that the shared page is viewed when a predetermined terminal device 2a or the like has referred to link information on the shared page.

(S105 through S111)

Processes from the step S105 to the step S111 (i.e., from a process in which the generating device 3a transmits link information (URI) of the shared page stored in the storage section 28 in the step S403 to the terminal device 2a to a process in which the terminal device 2a causes the display section 17 to display the shared page) are similar to those in Embodiment 1.

The above is the flow of processes based on the flowchart shown in FIG. 10.

According to the configuration, it is possible to distribute the process for generating a shared page to terminal devices 2a and the like which are owned by users. This makes it possible to bring about an effect of saving a processing resource in the generating device 3a.

### Embodiment 4

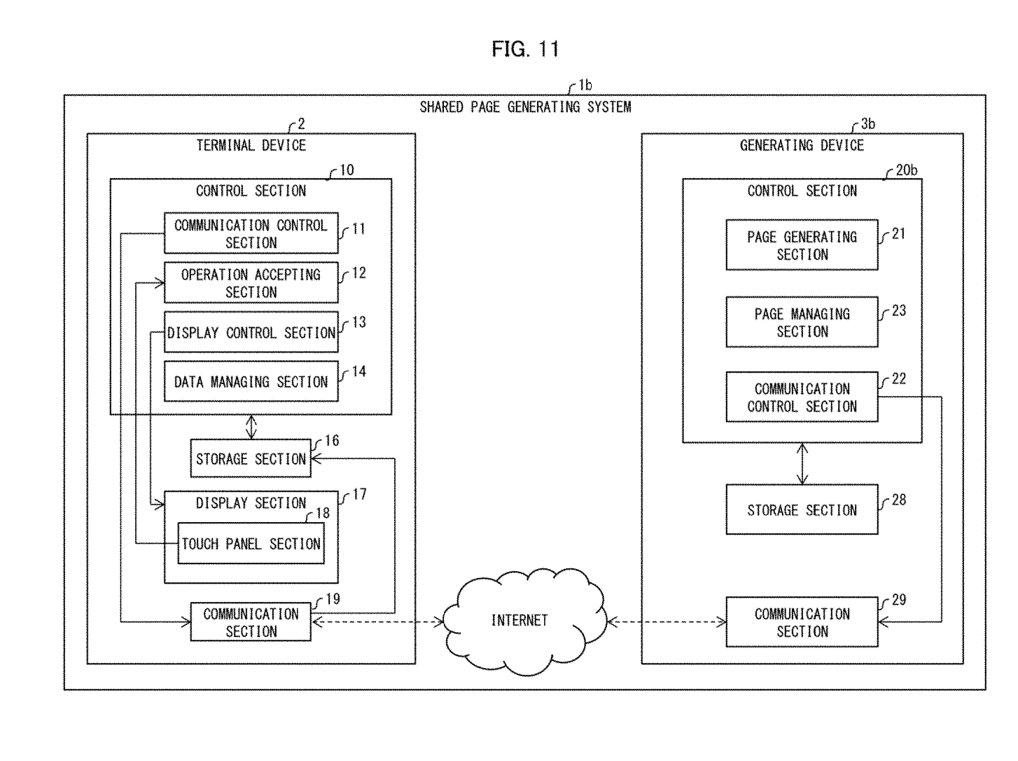

The following description will discuss another embodiment of the present invention with reference to FIG. 11.

In Embodiment 4, a configuration will be described in which a generating device sets a viewing time limit with respect to a shared page that is stored in a storage section.

[1. Configuration of Shared Page Generating System 1b]

FIG. 11 is a functional block diagram illustrating a shared page generating system 1b in accordance with Embodiment 4.

As illustrated in FIG. 11, in the shared page generating system 1b, a control section 20b includes a page managing section 23, as compared with the shared page generating system 1.

[2. Flow of Processes]

In the foregoing step S104 shown in FIG. 2 of Embodiment 1 or in the foregoing step S204 shown in FIG. 7 of Embodiment 2, the page managing section 23 sets a viewing time limit with respect to a shared page in association with generation of the shared page.

Information on the viewing time limit can be described as data in a header of the shared page or can be stored in the storage section 28 in a form of separate database.

The page managing section 23 refers to pieces of information on viewing time limits for each predetermined time period or every hour, and deletes, from the storage section 28, a shared page whose viewing time limit has been exceeded. In a case where pieces of information on viewing time limits are stored in the storage section 28 in the form of separate database, the page managing section 23 deletes an item associated with the exceeded viewing time limit from the database.

As such, the control section 20b (page managing section 23) sets a viewing time limit with respect to the shared page, and deletes, from the storage section 28, a shared page whose viewing time limit has been exceeded.

As an example of setting a viewing time limit, it is possible to employ a configuration in which, in a case where contents of a shared page are a recommendation of a program which has not been broadcasted, the page managing section 23 sets, as a viewing time limit, a time at which broadcasting of the program ends.

That is, the shared page is associated with a program which has not been broadcasted; and the control section 20b (page managing section 23) sets, as a viewing time limit, a time at which broadcasting of the program ends.

According to the configuration, old data which is unnecessary for many users is deleted, and this brings about an effect of saving a storage capacity of the storage section 28.

### Modification Example

The configuration illustrated in FIG. 9 is used in a case where a viewing time limit is set with respect to a shared page when the terminal device 2a generates the shared page, as described in Embodiment 3. In the above case, it is possible to employ a configuration in which the page generating section 15 determines a viewing time limit of a shared page. In this configuration, information on the viewing time limit is encompassed in a header portion of the shared page or is transmitted by the communication control section 11 to the generating device 3 via the communication section 19 as separate meta information.

### Additional Remarks on Embodiments 1 Through 4 and Modification Examples

Each of the page generating sections 21 included in the generating devices 3 and 3b and the page generating section 15 included in the terminal device 2a can generate a shared page in a display aspect that is suitable for viewing with use of, for example, a tablet terminal or a PC terminal, as well as a shared page in a display aspect that is suitable for viewing with use of a terminal such as a smart phone. In the above configuration, a terminal for viewing a shared page selects a shared page that corresponds to the terminal and displays the thus selected shared page on its screen.

[Example of Configuration Achieved by Software]

The control blocks (in particular, the communication control section and the operation accepting section 12) of the terminal device 2 and the control blocks (in particular, the page generating sections 21, the page managing section 23, and the communication control section 22) of the generating device 3 can be realized by a logic circuit (hardware) provided in an integrated circuit (IC chip) or the like or can be alternatively realized by software.

In the latter case, each of the terminal device 2 and the generating device 3 includes a computer that executes instructions of a program that is software realizing the foregoing functions. The computer includes, for example, at least one processor (control device) and at least one computer-readable storage medium storing the program. In a case where the processor in the computer reads out the program from the storage medium and executes the program, the object of the present invention is achieved. The processor can be, for example, a central processing unit (CPU). The storage medium can be a “non-transitory tangible medium” such as, for example, a tape, a disk, a card, a semiconductor memory, a programmable logic circuit, or the like, as well as a read only memory (ROM) or the like. The computer can further include a random access memory (RAM) in which the program is loaded. The program can be supplied to the computer via any transmission medium (such as a communication network or a broadcast wave) that can transmit the program. Note that an aspect of the present invention can also be achieved in the form of a computer data signal in which the program is embodied via electronic transmission and which is embedded in a carrier wave.

### Embodiment 5

In the foregoing embodiments, examples have been described in each of which one generating device 3, 3a, or 3b is used. Note, however, that the functions of the generating devices 3, 3a, and 3b can be achieved by separate servers. In a case where a plurality of servers are employed, the plurality of servers can be managed by the same operator or by different operators.

### Embodiment 6

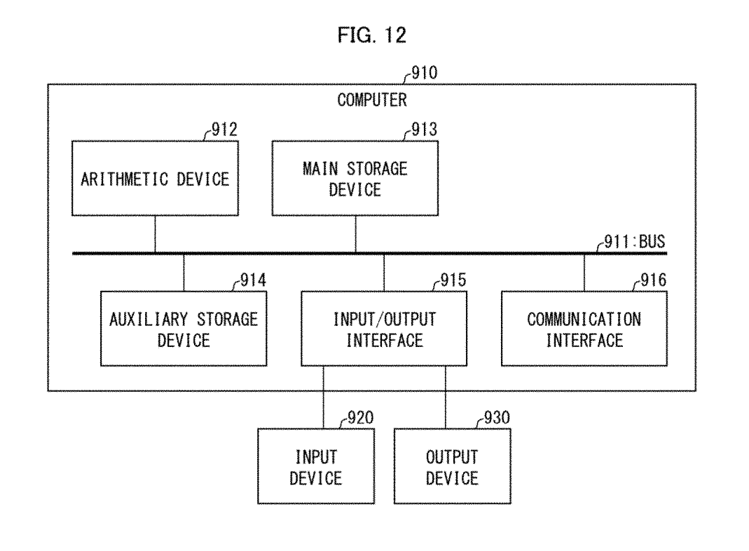

The blocks of the terminal devices 2 and 2a and the generating devices 3, 3a, and 3b can be realized by a logic circuit (hardware) provided in an integrated circuit (IC chip) or the like or can be alternatively realized by software. In the latter case, it is possible to configure each of the terminal devices 2 and 2a and the generating devices 3, 3a, and 3b with use of a computer as illustrated in FIG. 12.

FIG. 12 is a block diagram illustrating an example configuration of a computer 910 that can be used as any of the terminal devices 2 and 2a and the generating devices 3, 3a, and 3b. The computer 910 includes an arithmetic device 912, a main storage device 913, an auxiliary storage device 914, an input/output interface 915, and a communication interface 916 which are connected to each other via a bus 911. The arithmetic device 912, the main storage device 913, and the auxiliary storage device 914 can be, for example, a processor (e.g., a central processing unit: CPU), a random access memory (RAM), and a hard disk drive, respectively.

The input/output interface 915 is connected with (i) an input device 920 with which a user inputs various information to the computer 910 and (ii) an output device 930 via which the computer 910 outputs various information to the user. The input device 920 and the output device 930 can be incorporated into the computer 910 or can be devices which are (externally) connected to the computer 910. For example, the input device 920 can be a keyboard, a mouse, a touch sensor, or the like, and the output device 930 can be a display, a printer, a speaker, or the like. Alternatively, it is possible to employ a device having functions of both the input device 920 and the output device 930, such as a touch panel in which a touch sensor and a display are integrated. The communication interface 916 is an interface via which the computer 910 communicates with an external device.

The auxiliary storage device 914 stores various programs for causing the computer 910 to function as any of the terminal devices 2 and 2a and the generating devices 3, 3a, and 3b. The arithmetic device 912 loads, on the main storage device 913, the various programs stored in the auxiliary storage device 914 and executes a command included in each of the various programs so that the computer 910 functions as each section of the terminal devices 2 and 2a and the generating devices 3, 3a, and 3b.

Note that a storage medium which is included in the auxiliary storage device 914 for recording information such as the various programs only needs to be a computer-readable “non-transitory tangible medium” and can be, for example, a tape, a disk, a card, a semiconductor memory, a programmable logic circuit, or the like. The main storage device 913 can be omitted in a computer that can execute the program stored in the storage medium without loading the program on the main storage device 913. The number of each of the above devices (i.e., the arithmetic device 912, the main storage device 913, the auxiliary storage device 914, the input/output interface 915, the communication interface 916, the input device 920, and the output device 930) can be one or can be two or more.

The various programs can be obtained from outside of the computer 910. In this case, the various programs can be obtained via any transmission medium (such as a communication network or a broadcast wave). The present invention can also be achieved in the form of a computer data signal in which the various programs are embodied via electronic transmission and which is embedded in a carrier wave.

[Recap]

The generating device (3, 3a, 3b) in accordance with an aspect 1 of the present invention includes: a control section (20, 20a, 20b); and a communication section (29), the control section (20, 20a, 20b) obtaining data via the communication section (29), the data indicating a content which has been caused to be displayed on a display screen of a terminal device (2, 2a) by an application running on the terminal device (2, 2a), and the control section (20, 20a, 20b) generating, with reference to the data, a shared page including the content.

According to the configuration, it is possible to provide the generating device 3 which generates a shared page for sharing, with another user, even a screen display content that has been dynamically generated.

According to the generating device (3, 3b) in accordance with an aspect 2 of the present invention, in the aspect 1: the content is a dynamic web page which has been generated by the generating device (3, 3b) with reference to a request transmitted from the terminal device (2); the data is data indicative of the request or is data containing contents identical with the request; and the control section (20, 20b) generates, with reference to the data, a shared page from the dynamic web page.

According to the configuration, it is possible to provide the generating devices 3 and 3b each of which generates a shared page for sharing, with another user, a web page that has been dynamically generated.

The generating device (3, 3b) in accordance with an aspect 3 of the present invention can further include, in the aspect 1 or 2, a storage section (28), the control section (20, 20b) causing the storage section (28) to store the shared page such that the shared page is viewed when a predetermined terminal device (2, 2a) has referred to link information on the shared page.

According to the configuration, it is possible to provide the generating device 3 with which even a screen display content that has been dynamically generated can be shared with another user via a shared page.

According to the generating device (3, 3a, 3b) in accordance with an aspect 4 of the present invention, it is possible in the aspect 3 that the control section (20, 20a, 20b) sets a viewing time limit with respect to the shared page, and deletes, from the storage section (28), a shared page whose viewing time limit has been exceeded.

According to the configuration, old data which is unnecessary for many users is deleted, and this brings about an effect of saving a storage capacity of the storage section 28.

According to the generating device (3, 3a, 3b) in accordance with an aspect 5 of the present invention, it is possible in the aspect 4 that the shared page is associated with a program which has not been broadcasted; and the control section (20, 20a, 20b) sets, as a viewing time limit, a time at which broadcasting of the program ends.

The terminal device (2) in accordance with an aspect 6 of the present invention includes: a control section (10, 10a); a communication section (19); and a display section (17), the control section (10, 10a) running an application so as to cause the display section (17) to display a content, and the control section (10, 10a) transmitting, via the communication section (19), data for generating a shared page including the content.

According to the configuration, it is possible to provide the terminal device 2 with which even a screen display content that has been dynamically generated can be shared with another user via a shared page.

The terminal device (2a) in accordance with an aspect 7 of the present invention includes: a control section (10a); a communication section (19); and a display section (17), the control section (10a) running an application so as to cause the display section (17) to display a content, and the control section (10a) generating a shared page including the content and transmitting the shared page via the communication section (19).

According to the configuration, it is possible to distribute the process for generating a shared page to terminal devices 2a and the like which are owned by users. This makes it possible to bring about an effect of saving a processing resource in the generating device 3a.

According to the terminal device (2, 2a) in accordance with an aspect 8 of the present invention, it is possible in the aspect 6 or 7 that the control section (10, 10a) causes the shared page to be displayed in an aspect that corresponds to a type of the shared page.

According to the configuration, it is possible to provide the terminal devices 2 and 2a which can display a shared page in an aspect suitable for a type of the shared page.

The shared page generating system in accordance with an aspect 9 of the present invention includes: a terminal device (2); and a generating device (3), the terminal device (2) including a control section (10), a communication section (19), and a display section (17), the control section (10) running an application so as to cause the display section (17) to display a content, the control section (10) transmitting, via the communication section (19), data for generating a shared page including the content, the generating device (3) including a control section (20) and a communication section (29), the control section (20) obtaining data via the communication section (29), the data indicating the content which has been caused to be displayed on the display screen of the terminal device (2) by the application running on the terminal device (2), and the control section (20) generating the shared page with reference to the data.

The generating method in accordance with an aspect 10 of the present invention is a method for generating a shared page including a content with use of a generating device (3, 3b), and the generating method includes: a communication step of obtaining data indicating a content which has been caused to be displayed on a display screen of a terminal device (2, 2a) by an application running on the terminal device (2, 2a), the data being used to generate a shared page including the content; and a control step of generating the shared page with reference to the data, the shared page including the content.

The above configuration brings about an effect similar to that of the aspect 1.

The control program in accordance with an aspect 11 of the present invention can be a control program for causing a computer to serve as the terminal device described in any one of the aspects 6 through 8, the control program causing the computer to serve as the control section (10, 10a).

Each of the terminal devices 2 and 2a and the generating devices 3, 3a, and 3b in accordance with a corresponding one of the aspects of the present invention can be realized by a computer. In such a case, the present invention encompasses (i) a control program of each of the terminal devices 2 and 2a and the generating devices 3, 3a, and 3b which control program causes the computer to serve as the sections (software elements) included in the terminal devices 2 and 2a and the generating devices 3, 3a, and 3b for realizing the terminal devices 2 and 2a and the generating devices 3, 3a, and 3b and (ii) a computer-readable storage medium storing the control program.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b: Shared page generating system
2, 2a: Terminal device
3, 3a, 3b: Generating device
10, 10a, 20, 20a, 20b: Control section
11, 22: Communication control section
12: Operation accepting section
13: Display control section
14: Data managing section
15, 21: Page generating section
16, 28: Storage section
17: Display section
18: Touch panel section
19, 29: Communication section
23: Page managing section
40: Menu bar
41: Return button
42a, 42b, 42c, 42d: SNS button
43: Content display region
50: SNS message posting screen
51: Cancel button
52: Posting button
53: Text area
54: Share link information
910: Computer
911: Bus
912: Arithmetic device
913: Main storage device
914: Auxiliary storage device
915: Input/output interface
916: Communication interface
920: Input device
930: Output device

1. A generating device, comprising:
a control section; and
a communication section,
the control section obtaining data via the communication section, the data indicating a content which has been caused to be displayed on a display screen of a terminal device by an application running on the terminal device, and
the control section generating, with reference to the data, a shared page including the content.

2. The generating device as set forth in claim 1, wherein:
the content is a dynamic web page which has been generated by said generating device with reference to a request transmitted from the terminal device;
the data is data indicative of the request or is data containing contents identical with the request; and
the control section generates, with reference to the data, a shared page from the dynamic web page.

3. The generating device as set forth in claim 1, further comprising:
a storage section,
the control section causing the storage section to store the shared page such that the shared page is viewed when a predetermined terminal device has referred to link information on the shared page.

4. The generating device as set forth in claim 3, wherein:
the control section sets a viewing time limit with respect to the shared page; and
the control section deletes, from the storage section, a shared page whose viewing time limit has been exceeded.

5. The generating device as set forth in claim 4, wherein:
the shared page is associated with a program which has not been broadcasted; and
the control section sets, as a viewing time limit, a time at which broadcasting of the program ends.

6. A terminal device comprising:
a control section;
a communication section; and
a display section,
the control section running an application so as to cause the display section to display a content, and the control section transmitting, via the communication section, data for generating a shared page including the content.

7. A terminal device comprising:
a control section;
a communication section; and
a display section,
the control section running an application so as to cause the display section to display a content, the control section generating a shared page including the content, and the control section transmitting the shared page via the communication section.

8. The terminal device as set forth in claim 6, wherein:
the control section causes the shared page to be displayed in an aspect that corresponds to a type of the shared page.

9. A shared page generating system comprising:
a terminal device; and
a generating device,
the terminal device including a control section, a communication section, and a display section,
the control section running an application so as to cause the display section to display a content,
the control section transmitting, via the communication section, data for generating a shared page including the content,
the generating device including a control section and a communication section,
the control section of the generating device obtaining data via the communication section of the generating device, the data indicating the content which has been caused to be displayed on the display screen of the terminal device by the application running on the terminal device, and
the control section of the generating device generating the shared page with reference to the data.

10. A method for generating a shared page including a content with use of a generating device, said method comprising:
a communication step of obtaining data indicating a content which has been caused to be displayed on a display screen of a terminal device by an application running on the terminal device; and
a control step of generating a shared page with reference to the data, the shared page including the content.

11. A non-transitory computer readable storage medium that stores a control program for causing a computer to serve as a terminal device recited in claim 6, the control program causing the computer to serve as the control section.
